(19) United States
(12) Patent Application Publication
(10) Pub. No.: US 2003/0147509 A1
(43) Pub. Date: Aug. 7, 2003

(54) Method and apparatus for recording telephone calls

(76) Inventor: Steve LaVelle, Spokane, WA (US)

Correspondence Address: WELLS ST. JOHN ROBERTS GREGORY & MATKIN P.S., 601 W. FIRST AVENUE, SUITE 1300, SPOKANE, WA, 99201-3828, US

(21) Appl. No.: 10/067,614

(22) Filed: Feb. 4, 2002

(51) Int. Cl. H04M 1/64

(52) U.S. Cl. 379/68

(57) ABSTRACT

A method for recording a telephone call is described, and which includes, providing a telephone; providing a personal computer; providing a telephone signal and bifurcating the telephone signal into a first signal path which is supplied to the telephone, and a second signal path which is supplied to the personal computer; creating and storing a computer file by the personal computer which represents the telephone signal; and sending the file created by the personal computer to a remote server for storage and archive.

### TECHNICAL FIELD

The field of this invention relates to a communication recording method and apparatus used by businesses and other groups to record their telephone conversations, and more specifically to a method which facilitates the recording of these same calls for purposes of quality control; monitoring; and other assorted business purposes.

### BACKGROUND OF THE INVENTION

Telephone recording systems are commonly used by businesses to accomplish a wide variety of tasks. Such systems are especially important to companies which depend heavily on telephone contact with potential customers such as telemarketers; and others who utilize telephone banks as a part of their routine business operations. In the past, there has been commercially available recording equipment which allows direct marketers, for example, and other companies to record a certain percentage of their telephone conversations for purposes of quality control and monitoring of various business activities.

While these commercially available recording devices and other solutions have operated with some degree of success, they have several shortcomings which have detracted from their usefulness. For example, the commercially available equipment which is available, has been unduly expensive, and also is often encumbered by various sometimes onerous telecommunications requirements such as large amounts of band pass width to accommodate such recording systems. Additionally, the capture rate for such systems, and the large memory storage requirements for such recorded conversations are viewed, at least in some business segments, as abysmal. As noted, therefore, these aforementioned methods and devices have not been viewed as very attractive and have proved on many occasions to be less than ideal in terms of cost, capture rate, or ease of use.

A first aspect of the present invention, therefore, is to provide a recording system which will decrease costs; improve capture rate; and allow the previously recorded telephone recordings to be easily accessed and utilized for various purposes.

Another aspect of the present invention is to provide a method and apparatus which can be utilized with either a digital analog, or voice-over IP telephone system.

Yet a further aspect of the present invention is to provide a method and apparatus by which playback of the previously recorded telephone conversation is available through freeware, shareware, or commercially available computer software players; and distribution of the resulting recording is available through streaming from a web site, and is further deliverable to other remote servers.

Yet a further aspect of the present invention is to provide a method which can be employed for quality monitoring, training, verification, or other useful purposes by a multiplicity of different businesses.

These and other aspects and perceived advantages will become apparent hereinafter.

### BRIEF DESCRIPTION OF THE DRAWINGS

Preferred embodiments of the invention are described below with reference to the following accompanying drawings.

FIG. 1 is a greatly simplified diagrammatic representation showing an apparatus for implementing the present method.

FIG. 2 is a second greatly simplified block diagram which further illustrates an apparatus for implementing the present method.

FIG. 3 is a more detailed block diagram which further illustrates an apparatus for implementing the present method.

### DETAILED DESCRIPTION OF THE PREFERRED EMBODIMENTS

This disclosure of the invention is submitted in furtherance of the constitutional purposes of the U.S. Patent Laws “to promote the progress of science and useful arts” (Article 1, Section 8).

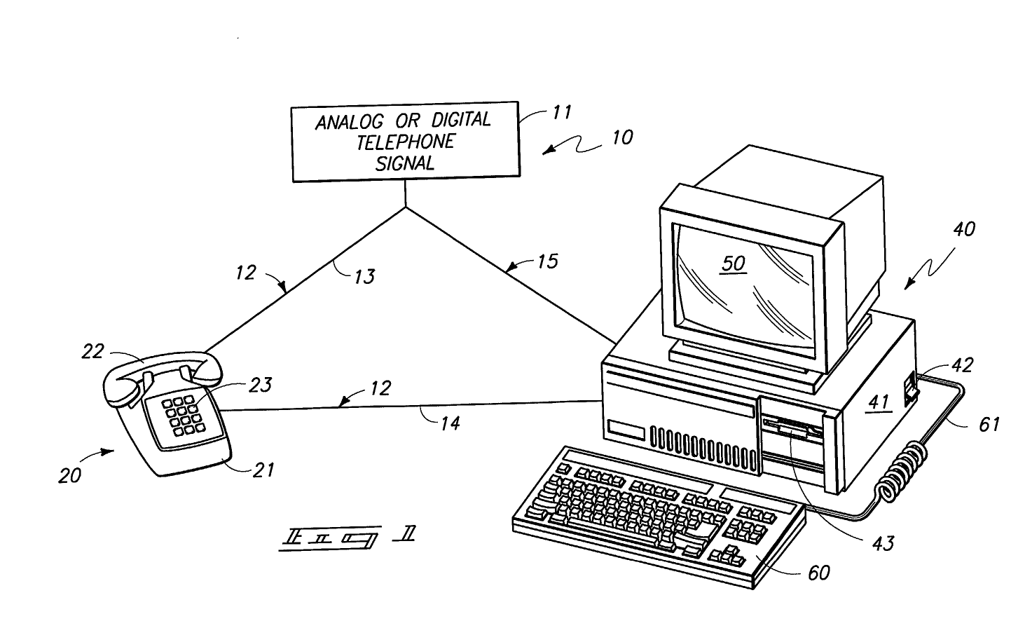

As best seen by reference to FIGS. 1-3, the method of the present invention is implemented by an apparatus which is generally shown by the numeral 10. As shown therein, the method for recording telephone calls of the present invention includes, as a first step, providing a digital or analog telephone signal which is generally indicated by the numeral 11. As shown in the Figures, the telephone signal is bifurcated into a first signal path 12 which is supplied to a telephone. This first signal path has a first portion or component 13 and a second portion or component 14, which electrically couples the telephone to a personal computer, which will be discussed in greater detail, hereinafter. Yet further the telephone signal 11 has a second signal path which is generally indicated by the numeral 15,and which is also coupled in signal transmitting relation relative to the personal computer as shown.

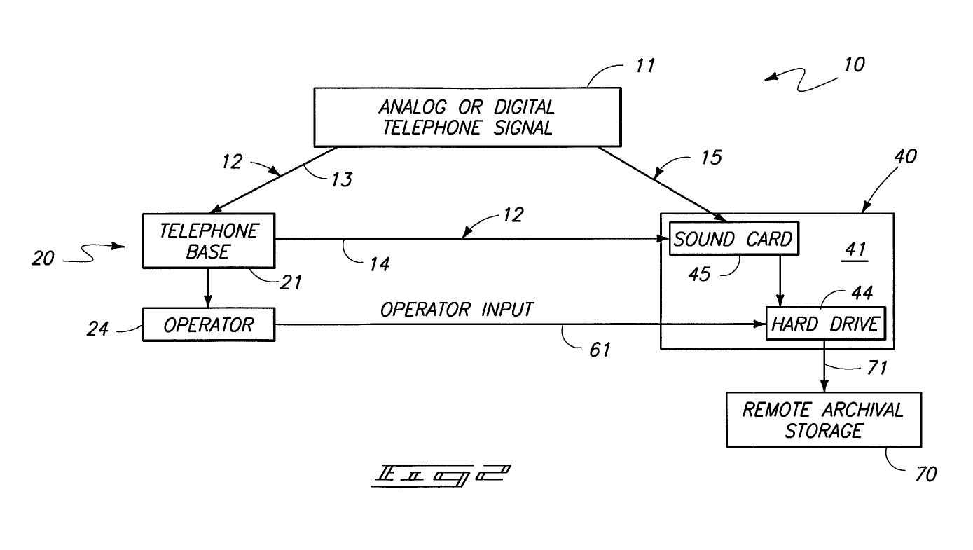

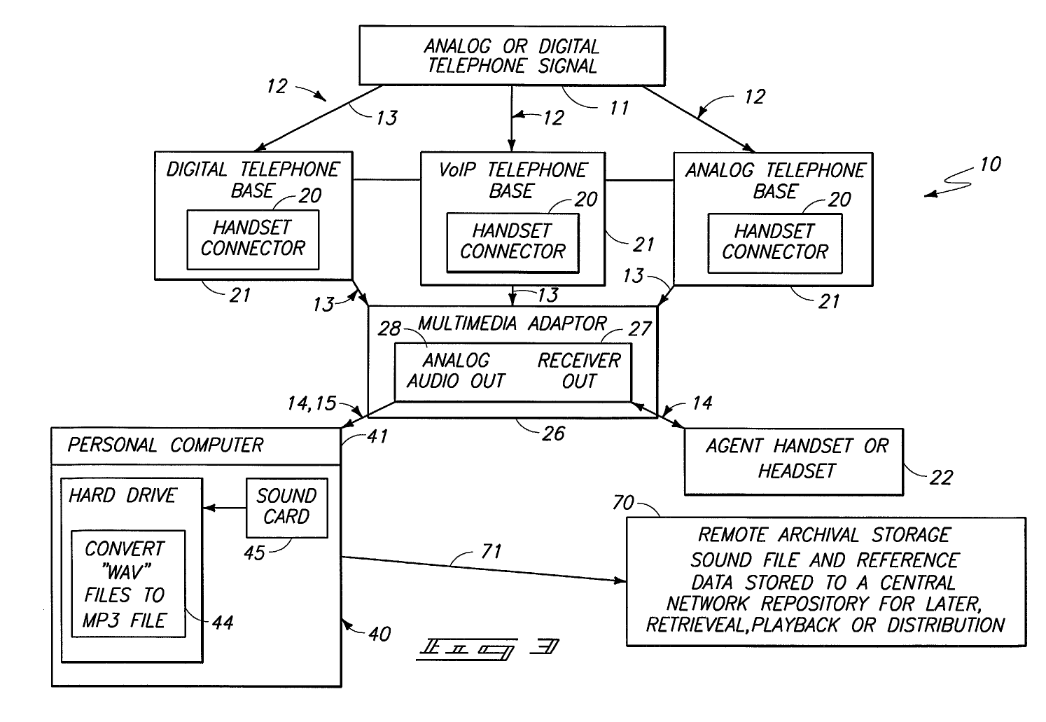

As seen in the Figures the method for recording telephone calls of the present invention is implemented, in part, by means of a telephone of conventional design, and which is generally indicated by the numeral 20. The telephone may be an analog, digital or voice-over IP type as seen in FIG. 3. Further the telephone may have a conventional handset as shown, in FIG. 1 or more typically a headset which permits hands-free operation by the operator. The telephone 20 has a main body or base portion 21 which is coupled in signal transmitting and receiving relation relative to the first signal path 12. The main body 21 is also electrically coupled to a handset or headset 22 which can be utilized by an operator 24 (FIG. 2). This electrical coupling is done by way of a multimedia adaptor 26 (seen in FIG. 3) and which is familiar to those skilled in the art. The multimedia adaptor includes a receiver out 27; and analog audio out ports 28. The main body 21 (FIG. 1) further has a keypad 23 which can be employed by the operator 24 in order to place calls on the telephone. Operator 24 receives a telephone call by lifting the receiver 22. The operator places a call in a customary fashion by employing the key pad 23.

As seen by reference to FIGS. 1-3, the method for recording telephone calls of the present invention is implemented, in part, by way of a personal computer which is generally indicated by the numeral 40. The personal computer 40 includes a base unit 41. The base unit 41 is coupled to a suitable power source not shown, and is selectively energized by way of a power switch 42. As seen in FIG. 1, the base unit 41 also has a conventional disk drive 43 and also encloses an internal hard drive 44 (FIGS. 2 and 3) which stores various data files. The hard drive 44 also stores and implements executable programs such as MP3; Lame.exe and file compression utilities which are available from http://www.mp3dev.org and which act upon data files stored on the hard drive. Still further, the base unit 41 includes a sound card 45 of traditional design and which is operable when employed to create a wave file which is utilized in the present method. As seen in FIG. 1, a video monitor 50 is electrically coupled to the base unit, and further, a keyboard or data input device 60 is coupled by way of a data conduit or cable 61, to the base unit, and in particular, to the hard drive 44.

As earlier noted the personal computer 40 is electrically coupled to a multimedia adaptor which is generally indicated by the numeral 26 (FIG. 3). As seen in that view, the multimedia adaptor is coupled in signal receiving relation relative to the first signal path 12 and more specifically the first and second portions 13 and 14 thereof. Yet further, the multimedia adaptor serves to bifurcate the telephone signal 11 such that the first signal path 12 is received by the handset or headset 22; and the second signal path 15 delivers the telephone signal 11 and any resulting conversation between the operator and a third party to the personal computer 40. As shown in FIG. 3 the multimedia adaptor includes an electrical coupler 27 which permits the handset or headset to be electrically coupled with same, and an output coupler 28 which supplies an analog audio output which is received by the personal computer 40.

Still further, in the method of the present invention, a remote computer server 70 is provided and which acts as a storage archival assembly (FIG. 2). The remote archival storage assembly 70 is electrically coupled to the hard drive 44 by means of a data path which is generally indicated by the numeral 71.

The method for recording telephone calls of the present invention and which is shown in each of the Figures comprises, providing a telephone signal 11, and bifurcating the telephone signal into a first signal path 12, and a second signal path 15, each of which are supplied to the personal computer 40; creating and storing a computer file by the personal computer which represents the telephone signal; and sending the file created by the personal computer 40 to a remote server 70 for storage and archive.

In the present method, the electronic file created by the personal computer 40 which represents the telephone conversation may be temporarily stored in a compressed format on the hard drive 44 of the personal computer 40 or; converted into an mp3 file. Yet further, it may be converted into a wave file by the sound card 45, and wherein the subsequently created wave file is converted to an mp3 format by utilizing executable programming identified as Lame.exe. This programming is available from http://www.mp3dev.org.

In the present method, and in one form of the invention, after the file, which represents the telephone conversation has been created and stored by the personal computer 40, but before the file is sent to a remote archival storage assembly or file server 70, the method comprises compressing the file utilizing a predetermined compression utility or protocol to a given size to facilitate storage on the remote archival storage assembly 70. This file will include reference data such that it may be easily identified at a later point in time.

In another form of the invention the file which is sent to the remote archival storage assembly 70 includes indicia which identifies the digital telephone signal 11 so that it may be retrieved and referenced at a future date for various business purposes.

As seen in FIGS. 1-3 the apparatus for recording telephone calls 10, comprises; a telephone 20; a personal computer 40; a bifurcated telephone signal 11 having first 12 and second signal paths 15, and wherein the first signal path is electrically coupled with the telephone base 21, and the second signal path 15 is electrically coupled with the personal computer 40; and wherein the personal computer creates an electronic file which represents the second signal path, and; a remote file server 70 is electrically coupled to the personal computer and which stores the electronic file created by the personal computer 40.

The method for recording a telephone call, of the present method also comprises; providing a telephone 20 for receiving a telephone call 11; providing a personal computer 40 having a sound card 45, and hard drive 44, and wherein the sound card is operable to create wave files, and the personal computer 40 has software for converting wave files into an mp3 format; bifurcating a signal representing the telephone call 11 to be recorded into a first path 12 which is supplied to the telephone 20, and a second path 15 which is supplied to the sound card 45 of the personal computer 40 which then creates a wave file; storing temporarily the wave file on the hard drive 44 of the personal computer 40; converting the wave file to an mp3 file; and sending the mp3 file to a remote electronic file server 70 for storage and archive. After the electronic file which represents the telephone signal 11 has been created and stored by the personal computer 40, but before the file is sent to a remote server 70, the method comprises compressing the electronic file utilizing a predetermined protocol to a given size to facilitate storage on the remote server 70.

### OPERATION

The operation of the described embodiment of the present invention is believed to be readily apparent and is briefly summarized at this point.

A method for recording a telephone call of the present invention comprises providing a telephone 20 for receiving a telephone call; providing a personal computer 40 having a sound card 45 and a hard drive 44; providing a signal 11 which represents the telephone call; bifurcating the signal into a first path 12 which is supplied to the digital telephone 20, and a second path 15 which is supplied to the sound card 45 of the personal computer 40; processing the second path 15 by the sound card 45 to create a file representing the second path; storing temporarily the electronic file created by the sound card 45 on the hard drive 44 of the personal computer 40; and, sending the file stored on the hard drive 44 to a remote file server 70 for storage and archive.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A method for recording telephone calls, comprising;
providing a telephone;
providing a personal computer;
providing a telephone signal and bifurcating the telephone signal into a first signal path which is supplied to the telephone, and a second signal path which is supplied to the personal computer;
creating and storing a computer file by the personal computer which represents the telephone signal; and
sending the file created by the personal computer to a remote server for storage archive.

2. A method as claimed in claim 1, and wherein the file created by the personal computer which represents the telephone signal is temporarily stored in a compressed format on the hard drive of the personal computer.

3. A method as claimed in claim 1, and wherein the file created by the personal computer which represents the telephone signal is converted into an mp3 file.

4. A method as claimed in claim 1, and wherein the file created by the personal computer which represents the telephone signal is converted into a wave file by a sound card, and wherein the wave file is converted to mp3 by utilizing Lame.exe.

5. A method as claimed in claim 1, and wherein after the step of creating and storing a computer file by the personal computer which represents the telephone signal, and before the step of sending the file created by the personal computer to a remote server, the method further comprises compressing the file utilizing a predetermined protocol to a given size to facilitate storage on the remote server.

6. A method as claimed in claim 1, and wherein the file sent to the remote server includes indicia which identifies the telephone call so that it may be retrieved at a future date.

7. An apparatus for recording telephone calls, comprising;
a telephone;
a personal computer;
a bifurcated telephone signal having first and second signal paths, and wherein the first signal path is electrically coupled with the telephone, and the second signal path is electrically coupled with the personal computer; and wherein the personal computer creates a file which represents the second signal path, and;
a remote file server electrically coupled to the personal computer and which stores the file created by the personal computer.

8. A method for recording a telephone call, comprising;
providing a telephone for receiving and placing a telephone call;
providing a personal computer having a sound card, and hard drive, and wherein the sound card is operable to create wave files, and the personal computer has software for converting wave files into an mp3 format;
bifurcating a signal representing the telephone call to be recorded into a first path which is supplied to the telephone, and a second path which is supplied to the sound card of the personal computer which then creates a wave file;
storing temporarily the wave file on the hard drive of the personal computer;
converting the wave file to an mp3 file, and;
sending the mp3 file to a remote file server for storage and archive.

9. A method as claimed in claim 8, and wherein after the step of temporarily storing the file created by the sound card on the hard drive of the computer, and before the step of sending the file stored on the hard drive to the remote server, the method further comprising compressing the file utilizing a predetermined protocol to a predetermined size to facilitate storage on the remote server.

10. A method as claimed in claim 8, and wherein the file created by the sound card is a wave file, and wherein the wave file is converted to mp3 by utilizing Lame.exe.

11. A method as claimed in claim 8, and wherein the file sent to the remote server includes indicia which identifies the recording so that it may be retrieved at a future date.

12. A method for recording a telephone call comprising;
providing a telephone for receiving a telephone call;
providing a personal computer having a sound card and a hard drive;
providing an electrical signal which represents the telephone call;
bifurcating the electrical signal into a first path which is supplied to the telephone, and a second path which is supplied to the sound card of the personal computer;
processing the electrical signal in the second path by the sound card to create an electronic file representing the second path;
storing temporarily the electronic file created by the sound card on the hard drive of the personal computer; and,
sending the file stored on the hard drive to a remote file server for storage and archive.

13. A method as claimed in claim 12, and wherein after the step of temporarily storing the electronic file created by the sound card on the hard drive of the computer, and before the step of sending the file stored on the hard drive to the remote server, the method further comprises compressing the electronic file utilizing a predetermined protocol to a predetermined size to facilitate storage on the remote server.

14. A method as claimed in claim 12, and wherein the protocol is mp3.

15. A method as claimed in claim 12, and wherein the file created by the sound card is a wave file, and wherein the wave file is converted to mp3 by utilizing Lame.exe.
